(19) United States
(12) Patent Application Publication
(10) Pub. No.: US 2024/0211773 A1
(43) Pub. Date: Jun. 27, 2024

(54) DYNAMIC ID GENERATION FOR CONNECTED VEHICLE SYSTEMS

(71) Applicant: FORD GLOBAL TECHNOLOGIES, LLC, Dearborn, MI (US)

(72) Inventors: Omar MAKKE, Lyon Township, MI (US); James DAY, Dearborn, MI (US)

(21) Appl. No.: 18/069,835

(22) Filed: Dec. 21, 2022

(51) Int. Cl. G06N 5/022

(52) U.S. Cl. CPC G06N 5/022

(57) ABSTRACT

A knowledge database describes a plurality of triggers, each trigger including a first condition for activating the trigger and a second condition for deactivating the trigger. A controller of the vehicle processes the triggers defined by the knowledge database, including to compare data elements of connected data messages with the conditions of the triggers. The controller augments the connected data messages that occur while the respective trigger is activated with a generated dynamic ID corresponding to the activating of the respective trigger.

### TECHNICAL FIELD

Aspects of the present disclosure generally relate to using ontologies or other knowledge databases to group vehicle events by dynamic identifiers for enhanced data access.

### BACKGROUND

Connected vehicles may send data to a cloud system. As the cloud system receives thousands of messages from millions of vehicles, this quantity of data may become large.

### SUMMARY

In one or more illustrative examples, a system for using an ontology to augment connected data messages is provided. The system includes a storage of a vehicle, configured to maintain a knowledge database describing a plurality of triggers, each trigger including a first condition for activating the trigger and a second condition for deactivating the trigger; and a controller of the vehicle, programmed to process the triggers defined by the knowledge database, including to compare data elements of the connected data messages with the conditions of the triggers, and augment each of the connected data messages that occur while the respective trigger is activated with a generated dynamic identifier (ID) corresponding to the activating of the respective trigger.

In one or more illustrative examples, a method for using a knowledge database to augment connected data messages is provided. The method includes maintaining, to a storage of a vehicle, the knowledge database describing a plurality of triggers, each trigger including a first condition for activating the trigger and a second condition for deactivating the trigger; processing, by a controller of the vehicle, the triggers defined by the knowledge database, including to compare data elements of the connected data messages with the conditions of the triggers; and augmenting, by the controller of the vehicle, each of the connected data messages that occur while the respective trigger is activated with a generated dynamic ID corresponding to the activating of the respective trigger.

In one or more illustrative examples, non-transitory computer-readable medium comprising instructions for using a knowledge database to augment connected data messages that, when executed by a processor of a controller of a vehicle, cause the controller to perform operations including to receive the knowledge database over a communication network from a cloud server, the knowledge database including a data element mapping of signals of the vehicle to data elements of the knowledge database and a plurality of triggers, each trigger including a first condition for activating the trigger and a second condition for deactivating the trigger; process, by a controller of the vehicle, the triggers defined by the knowledge database, including to compare data elements of the connected data messages with the conditions of the triggers; augment, by the controller of the vehicle, each of the connected data messages that occur while the respective trigger is activated with a generated dynamic ID corresponding to the activating of the respective trigger; and send the augmented connected data messages to the cloud server.

### BRIEF DESCRIPTION OF THE DRAWINGS

FIG. 1 illustrates an example system for using knowledge databases to conceptually group vehicle events by dynamic identifiers for enhanced data access;

FIG. 2 illustrates an example knowledge database for a vehicle;

FIG. 3 illustrates an example of the operation of the data mapping application of the telematics control unit (TCU) to process connected vehicle data using the knowledge database;

FIG. 4 illustrates an example of connected data message augmented with dynamic identifiers (IDs) as collected by the cloud server;

FIG. 5 illustrates an example process for utilizing the knowledge database to augment connected data messages with dynamic IDs;

FIG. 6 illustrates an example process for querying the connected data messages according to the dynamic IDs; and

FIG. 7 illustrates an example of a computing device for implementing aspects of using knowledge databases to conceptually group connected data messages by dynamic ID for enhanced data access.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications.

Vehicles equipped with a modem may send messages to a cloud system over time. For example, a decision to send the messages may be determined by predefined triggers (such as brakes being applied, or a door being opened). In some systems, scripts may be deployed to the vehicles to allow these dynamic triggers to be implemented.

As the cloud system receives thousands of messages from millions of vehicles, it becomes increasingly difficult and resource intensive to extract events that occurred within defined parameters, such as during a day, or during an ignition cycle, or when the vehicle idles and then drives. This difficulty may arise because the messages sent are a snapshot of vehicle state, but that snapshot has no link to a human-defined concept such as a trip, or ignition cycle. Thus, to find events that occurred in a time window defined by some trigger (e.g., what happened between door opened and door closed) requires the cloud system to parse through all the messages and apply complicated logic. This makes the queries take significant time and slows down query performance.

Aspects of the disclosure describe the use of ontologies or other knowledge databases to dynamically define triggers for different types of vehicles on the road, so that the cloud system may easily group the events by concept such as a trip, or charge cycle. This may allow for enhanced querying of the vehicle data by client devices.

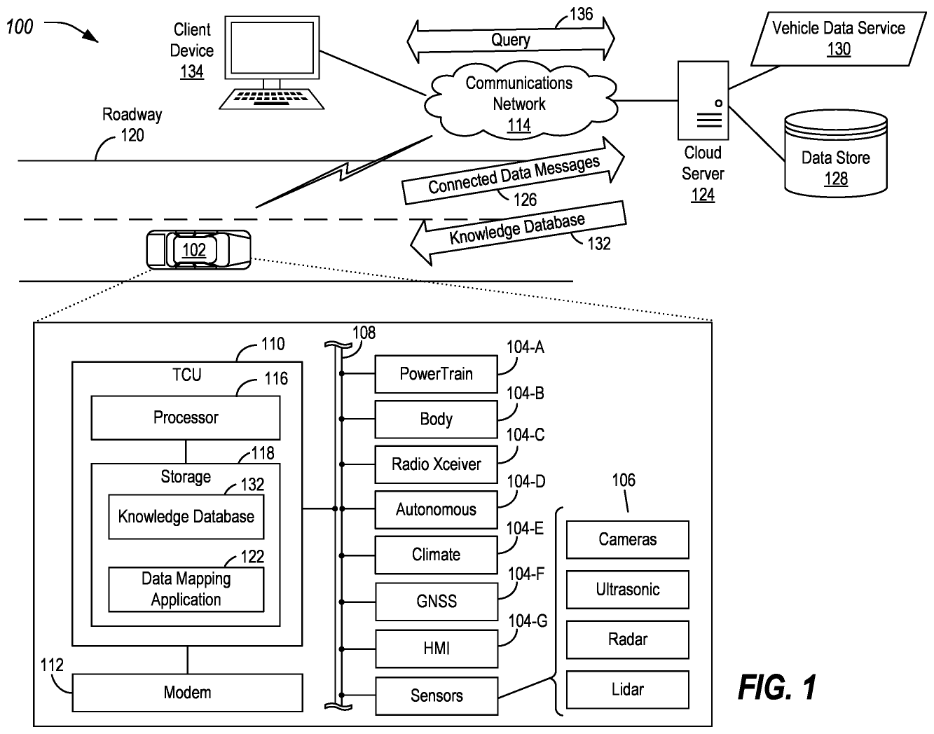

FIG. 1 illustrates an example system 100 for using knowledge databases 132 to conceptually group vehicle 102 events by dynamic identifiers for enhanced data access. As discussed in detail herein, a knowledge database 132 may be used to augment connected data messages 126. The system 100 includes a storage 118 of a vehicle 102, configured to maintain the knowledge database 132. A TCU 110 or other controller 104 of the vehicle 102 may be programmed to process the knowledge database 132, including to augment connected data messages 126 with information based on the conditions specified by the knowledge database 132.

The vehicle 102 may include various types of automobile, crossover utility vehicle (CUV), sport utility vehicle (SUV), truck, recreational vehicle, boat, plane or other mobile machine for transporting people or goods. Such vehicles 102 may be human-driven or autonomous. In many cases, the vehicle 102 may be powered by an internal combustion engine. As another possibility, the vehicle 102 may be a battery electric vehicle (BEV) powered by one or more electric motors. As a further possibility, the vehicle 102 may be a hybrid electric vehicle (HEV) powered by both an internal combustion engine and one or more electric motors, such as a series hybrid electric vehicle (SHEV), a parallel hybrid electrical vehicle (PHEV), or a parallel/series hybrid electric vehicle (PSHEV). Alternatively, the vehicle 102 may be an Automated Vehicle (AV). The level of automation may vary between variant levels of driver assistance technology to a fully automatic, driverless vehicle. As the type and configuration of vehicle 102 may vary, the capabilities of the vehicle 102 may correspondingly vary. As some other possibilities, vehicles 102 may have different capabilities with respect to passenger capacity, towing ability and capacity, and storage volume. For title, inventory, and other purposes, vehicles 102 may be associated with unique identifiers, such as vehicle identification numbers (VINs). It should be noted that while automotive vehicles 102 are being used as examples of traffic participants, other types of traffic participants may additionally or alternately be used, such as bicycles, scooters, and pedestrians.

The vehicle 102 may include a plurality of controllers 104 configured to perform and manage various vehicle 102 functions under the power of the vehicle battery and/or drivetrain. As depicted, the example vehicle controllers 104 are represented as discrete controllers 104 (i.e., 104A through 104G). However, the vehicle controllers 104 may share physical hardware, firmware, and/or software, such that the functionality from multiple controllers 104 may be integrated into a single controller 104, and that the functionality of various such controllers 104 may be distributed across a plurality of controllers 104.

As some non-limiting vehicle controller 104 examples: a powertrain controller 104A may be configured to provide control of engine operating components (idle control components, fuel delivery components, emissions control components, etc.) and for monitoring status of such engine operating components (status of engine codes); a body controller 104B may be configured to manage various power control functions such as exterior lighting, interior lighting, keyless entry, remote start, and point of access status verification (closure status of the hood, doors and/or trunk of the vehicle 102); a radio transceiver controller 104C may be configured to communicate with key fobs, mobile devices, or other local vehicle 102 devices; an autonomous controller 104D may be configured to provide commands to control the powertrain, steering, or other aspects of the vehicle 102; a climate control management controller 104E may be configured to provide control of heating and cooling system components (compressor clutch, blower fan, temperature sensors, etc.); a global navigation satellite system (GNSS) controller 104F may be configured to provide vehicle location information; and a human-machine interface (HMI) controller 104G may be configured to receive user input via various buttons or other controls, as well as provide vehicle status information to a driver, such as fuel level information, engine operating temperature information, and current location of the vehicle 102.

The controllers 104 of the vehicle 102 may make use of various sensors 106 in order to receive information with respect to the surroundings of the vehicle 102. In an example, these sensors 106 may include one or more of cameras (advanced driver-assistance system (ADAS) cameras), ultrasonic sensors, radar systems, and/or lidar systems.

One or more vehicle buses 108 may include various methods of communication available between the vehicle controllers 104, as well as between a TCU 110 and the vehicle controllers 104. As some non-limiting examples, the vehicle bus 108 may include one or more of a vehicle controller area network (CAN), an Ethernet network, and a media-oriented system transfer (MOST) network.

The TCU 110 may include network hardware configured to facilitate communication between the vehicle controllers 104 and with other devices of the system 100. For example, the TCU 110 may include or otherwise access a modem 112 configured to facilitate communication over a communication network 114. The TCU 110 may, accordingly, be configured to communicate over various protocols, such as with the communication network 114 over a network protocol (such as Uu). The TCU 110 may, additionally, be configured to communicate over a broadcast peer-to-peer protocol (such as PC5), to facilitate cellular vehicle-to-everything (C-V2X) communications with devices such as other vehicles 102. It should be noted that these protocols are merely examples, and different peer-to-peer and/or cellular technologies may be used.

The TCU 110 may include various types of computing apparatus in support of performance of the functions of the TCU 110 described herein. In an example, the TCU 110 may include one or more processors 116 configured to execute computer instructions, and a storage 118 medium on which the computer-executable instructions and/or data may be maintained. A computer-readable storage medium (also referred to as a processor-readable medium or storage 118) includes any non-transitory (tangible) medium that participates in providing data (instructions) that may be read by a computer (by the processor(s)). In general, the processor 116 receives instructions and/or data, from the storage 118, etc., to a memory and executes the instructions using the data, thereby performing one or more processes, including one or more of the processes described herein. Computer-executable instructions may be compiled or interpreted from computer programs created using a variety of programming languages and/or technologies, including, without limitation, and cither alone or in combination, Java, C, C++, C#, Fortran, Pascal, Visual Basic, Python, Java Script, Perl, etc.

The TCU 110 may be configured to include one or more interfaces from which vehicle information may be sent and received. This information can be sensed, recorded, and sent to one or more cloud servers 124. In an example, similar to the TCU 110, the cloud server 124 may also include one or more processors (not shown) configured to execute computer instructions, and a storage medium (not shown) on which the computer-executable instructions and/or data may be maintained.

The TCU 110 may be configured to facilitate the collection of vehicle information from the vehicle controllers 104 connected to the one or more vehicle buses 108. While only a single vehicle bus 108 is illustrated, it should be noted that in many examples, multiple vehicle buses 108 are included, usually with a subset of the controllers 104 connected to each vehicle bus 108. Accordingly, to access a given controller 104, the TCU 110 may be configured to maintain a mapping of which vehicle buses 108 are connected to which controllers 104, and to access the corresponding vehicle bus 108 for a controller 104 when communication with that particular controller 104 is desired.

The TCU 110 may be further configured to transmit connected data messages 126 over the communication network 114 for reception by the cloud server 124. In an example, the management of sending connected data messages 126 may be handled by a data mapping application 122 executed by the TCU 110. The connected data messages 126 may include signals retrieved from the controllers 104 and/or the sensors 106 over the vehicle buses 108. The connected data messages 126 may include data descriptive of various vehicle signals along the vehicle bus 108. These signals may be useful in the identification of conditions along the roadway 120.

The connected data messages 126 may further include contextual information with respect to the location of the vehicle 102 when the events occurred. In an example, the TCU 110 may also capture location information from the GNSS controller 104F that may be used to augment the captured event information with locations of where the vehicle 102 was when the events occurred. In another example, the time at which the event occurred may be included as contextual information. The connected data messages 126 captured by the TCU 110 may also include, as some non-limiting examples, latitude, longitude, time, heading angle, speed, throttle position, brake status, steering angle, headlight status, wiper status, external temperature, turn signal status, ambient temperature or other weather conditions, etc.

In an example, the collection of connected data messages 126 may be performed in an event-based manner, in which the vehicles 102 send the connected data messages 126 to the cloud server 124 responsive to occurrence of the event. For instance, when an event is indicated by the vehicle 102 (such as by a sharp impulse in an accelerometer signal), the connected data messages 126 message may be sent from the modem 112 of the vehicle 102 to the cloud server 124, the message containing event information (loss magnitude, indicator type, etc.) as well as the GNSS coordinates at which the event occurred. Alternatively, this information can also be compiled from continuously sampled data from the vehicle buses 108, e.g., to the storage 118 of the TCU 110, which may allow for batch uploading of connected data messages 126 from the vehicle 102.

In addition to compiling event data from the sensors 106, the TCU 110 (and/or other controllers of the vehicle 102) may utilize edge-processing capabilities to augment the connected data messages 126 based on a knowledge database 132. Knowledge databases 132 are a type of data store which describes the knowledge of what things exist and how these things relate to each other. An knowledge database 132 for a vehicle 102, for example, may contains types of vehicles 102, part numbers in each vehicle 102, which parts can be in what vehicles 102, what signals are generated by what features, etc. As explained in detail herein, the knowledge database 132 may be used to associate the connected data messages 126 with higher-level concepts, in the form of data identifiers.

Following the extraction of event information, as well as the use of the knowledge database 132 to add identifiers to the connected data messages 126, the connected data messages 126 may be sent to the cloud server 124 via the on-vehicle modem 112 (or in other example, via a cell phone connected to the vehicle 102).

The cloud server 124 may be configured to receive the connected data messages 126 and store the connected data messages 126 in a data store 128. This information may be maintained for querying by a vehicle data service 130. The system 100 may further include one or more client devices 134 configured to access the cloud server 124 over the communication network 114. Using the services of the vehicle data service 130 of the cloud server 124, one or more client devices 134 may be configured to perform queries 136 of the connected data messages 126 for various information.

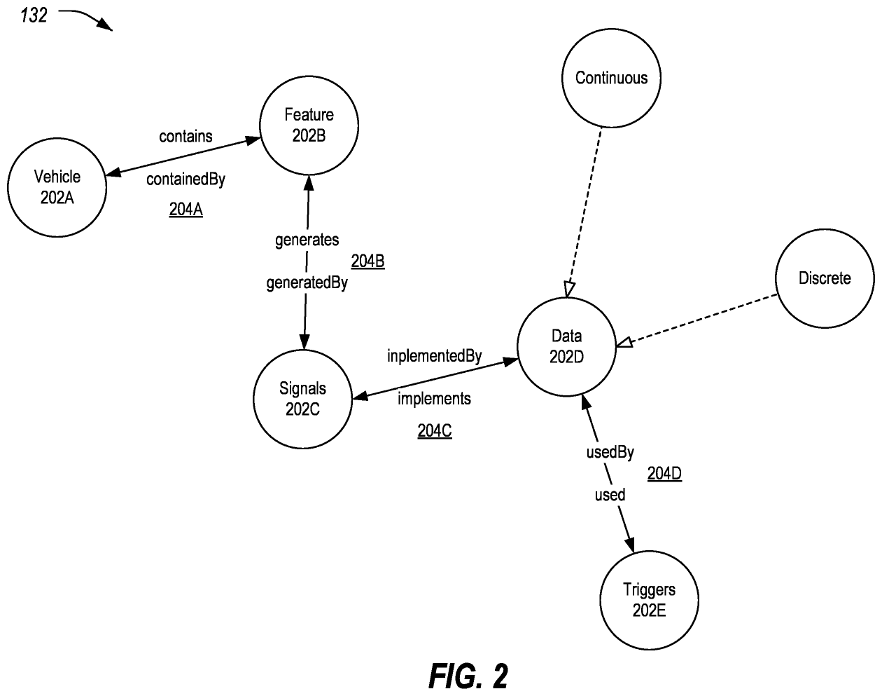

FIG. 2 illustrates an example knowledge database 132 for a vehicle 102. As shown, the knowledge database 132 is in the form of a data graph or ontology, but this is only an example and other forms of knowledge database 132 may be used. The knowledge database 132 may define various ontology elements 202, as well as ontology relationships 204 between the elements, which are represented as lines. As shown, the example knowledge database 132 includes ontology elements 202 for a vehicle 202A, features 202B, signals 202C, data elements 202D, and triggers 202E.

As indicated by ontology relationship 204A, the vehicle 202A contains the features 202B and the features 202B are contained by the vehicle 202A. As shown by ontology relationship 204B, the signals 202C generate the features 202B, while the features 202B are generated by the signals 202C. As shown by ontology relationship 204C, the signals 202C are implemented by the data elements 202D, and the data elements 202D implements the signals 202C. As shown by ontology relationship 204D, the data elements 202D is used by the triggers 202E and the triggers 202E use the data elements 202D. Also as shown, the data elements 202D may be continuous 202F (e.g., a solid on or off) or discrete 202G in form (e.g., a packetized message), as received to the TCU 110 via the vehicle buses 108 and/or sensors 106.

The features 202B of the vehicle 202A may generate signals 202C based on the operation of the vehicle 202A. The signals 202C may refer to electronic messages that include information indicative of an event (or non-occurrence of an event). For example, a signal 202C may be generated responsive to the opening of a door of the vehicle 202A. Or, a signal 202C may be generated responsive to the vehicle 202A transitioning from park to a motive mode. As different vehicles 202A have different features 202B and capabilities, the different vehicles 202A may generate different signals 202C. In one example, a first model of vehicle 202A may raise a “door_fr” signal 202C over a CAN bus for the opening of front door, but a second model of vehicle 202A may instead raise a “doorStatus” signal 202C over an Ethernet bus to indicate the same event.

The data elements 202D may refer to various signals 202C that may be raised by the vehicles 202A. For instance, an element of the data elements 202D may be used to map both the “door_fr” and the “doorStatus”, signals 202C to the same data element “DoorStatus”. Thus, the data element 202D layer of the knowledge database 132 may serve to map disparate signals 202C across different vehicle 202A models into a consistent interface for use by the triggers 202E. An example data mapping for such a signal is shown in Table 1.

TABLE 1
Example Data Element Signal Mapping

| Data Element | Value |
|---|---|
| Name | doorStatus |
| Signals | door_fr |
| | doorStatus |

The triggers 202E may specify conditions that, when satisfied, cause dynamic identifiers to be associated with the data elements 202D. The triggers 202E may accordingly be defined using the data elements 202D to indicate the conditions in a manner that is abstracted from the implementation of the signals 202C. The triggers 202E may be defined in the knowledge database 132 to point to various variables of the data elements 202D defined in the knowledge database 132. In some examples, a trigger 202E may be satisfied based on the presence (or absence for a defined period of time) of a data element 202D (e., a door open signal is received over a vehicle bus 108 by the TCU 110). In other examples, a trigger 202E may be satisfied based on the occurrence of a data element 202D having a specific value (e.g., where door is equal to 1 to indicate an open door condition).

As a more detailed example, the data elements 202D may define the following elements as shown in Table 2.

TABLE 2
Example Data Element Parameter Definition

| Data Element | Value |
|---|---|
| IgnitionStatus | ON when the vehicle is turned on; |
| | OFF when the vehicle is turned off. |
| PropulsionReady | TRUE when the vehicle can be transitioned to the |
| | motive mode; FALSE otherwise. |

Continuing with the Example, Table 3 defines an example of a trigger 202E utilizing the data elements defined in Table 2.

TABLE 3
Example Trigger Element Definition

| Trigger | Value |
|---|---|
| Name | IgnitionCycle |
| Dependencies | IgnitionStatus; PropulsionReady |
| Activate Condition | IgnitionStatus = ON AND PropulsionReady = True |
| Deactivate | IgnitionStatus = OFF OR PropulsionReady = False |
| Condition | |

The knowledge database 132 may be maintained by the cloud server 124. Updates to the knowledge database 132 may be sent from the cloud server 124 to the vehicle 102 over the communication network 114, which may then be received by the TCU 110 of the vehicle 102 and applied to connected data messages 126 to be sent from the TCU 110 to the cloud server 124. Updated knowledge databases 132 may be sent from the cloud server 124 to the vehicle 102 to update the triggers 202E, periodically, or from time to time.

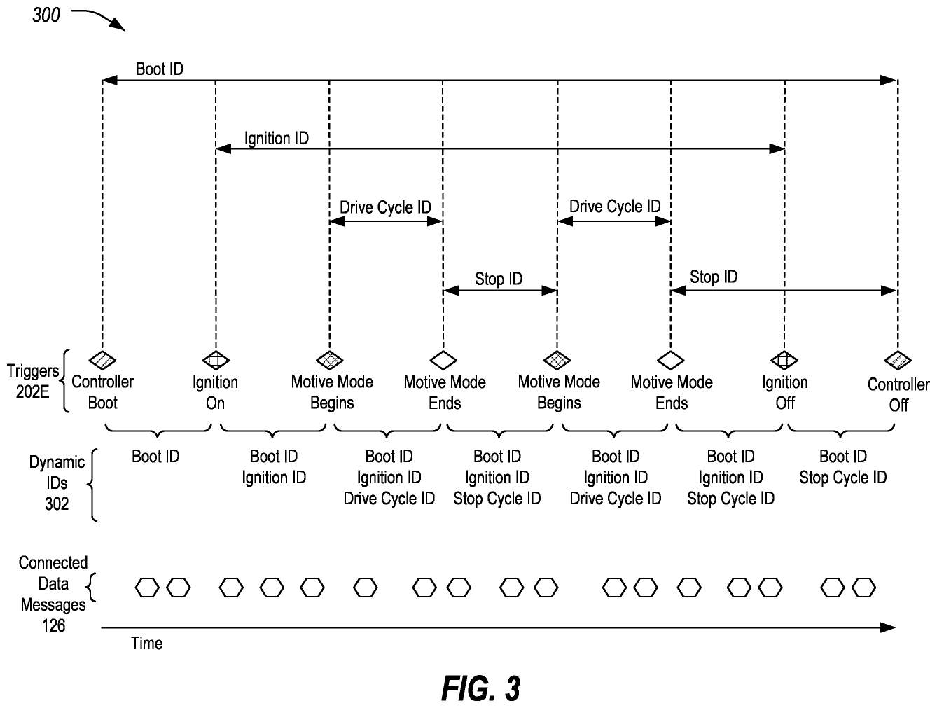

FIG. 3 illustrates an example 300 of the operation of the data mapping application 122 of the TCU 110 to process connected data messages 126 using the knowledge database 132. As shown, dynamic ID 302 are applied to the connected data message 126 based on triggers 202E of the knowledge database 132.

In the example 300, triggers 202E are defined for a plurality of events of interest. A boot ID trigger 202E may be defined by the knowledge database 132 to add a dynamic ID 302 whenever a main controller, such as the TCU 110 or a vehicle gateway controller 104, is powered on. An ignition cycle trigger 202E may be defined by the knowledge database 132 to add a dynamic ID 302 whenever the vehicle 102 is keyed on or off. A drive cycle trigger 202E may be defined by the knowledge database 132 to add a dynamic ID 302 whenever the vehicle 102 enters into a motive mode. A stop cycle trigger 202E may be defined by the knowledge database 132 to add a dynamic ID 302 whenever the vehicle 102 exits the motive mode.

The dynamic IDs 302 may be generated as unique values each time the trigger 202E occurs. Or, in another example, the dynamic IDs 302 may be pre-generated each time the vehicles 102 is started. For instance, the dynamic IDs 302 may be created responsive to the vehicle 102 loading the triggers 202E from the knowledge database 132.

In an example, the dynamic IDs 302 may be generated using a hash of various values. For instance, a dynamic ID 302 may be generated as a hash of VIN, current timestamp, an incremented value, and/or an identifier of the trigger 202E that is satisfied. The hash may be used to ensure the dynamic IDs 302 are of consistent length and/or entropy. In another example, the dynamic IDs 302 may be randomly generated values.

The dynamic IDs 302 may be incorporated into the connected data messages 126 that occur during the time that the corresponding triggers 202E are satisfied. To use the illustrated example, proceeding from the earliest to latest time shown in the example 300, the connected data messages 126 occurring after the controller boot trigger 202E is satisfied are associated with a dynamic ID 302 corresponding to the controller boot trigger 202E. The connected data messages 126 occurring after the ignition on trigger 202E is satisfied are associated with the dynamic ID 302 corresponding to the boot ignition trigger 202E and also to a second dynamic ID 302 corresponding to the ignition cycle. The connected data messages 126 occurring after the motive mode satisfies the drive cycle trigger 202E are associated with the dynamic ID 302 corresponding to the boot ignition trigger 202E, to a second dynamic ID 302 corresponding to the ignition cycle, and to a third dynamic ID 302 corresponding to the drive cycle.

The connected data messages 126 occurring after the motive mode ends satisfies the stop cycle trigger 202E are associated with the dynamic ID 302 corresponding to the boot ignition trigger 202E, to a second dynamic ID 302 corresponding to the ignition cycle, and to a third dynamic ID 302 corresponding to the stop cycle. The drive cycle ID is no longer included, as that drive cycle has ended.

The connected data messages 126 occurring, after the second motive mode satisfies the drive cycle trigger 202E again, are associated with the dynamic ID 302 corresponding to the boot ignition trigger 202E, to a second dynamic ID 302 corresponding to the ignition cycle, and to a third dynamic ID 302 corresponding to the second drive cycle. The second drive cycle ID is a different ID value from the first drive cycle ID.

The connected data messages 126 occurring, after the second motive mode ends satisfies the stop cycle trigger 202E again, are associated with the dynamic ID 302 corresponding to the boot ignition trigger 202E, to a second dynamic ID 302 corresponding to the ignition cycle, and to a third dynamic ID 302 corresponding to the second stop cycle. The second stop cycle ID is a different ID value from the first stop cycle ID.

The connected data messages 126 occurring, after the ignition mode end completes the ignition trigger 202E, are associated with the dynamic ID 302 corresponding to the boot ignition trigger 202E, and a second dynamic ID 302 corresponding to the second stop cycle. The ignition cycle dynamic ID 302 is no longer included, as the ignition trigger 202E is no longer satisfied.

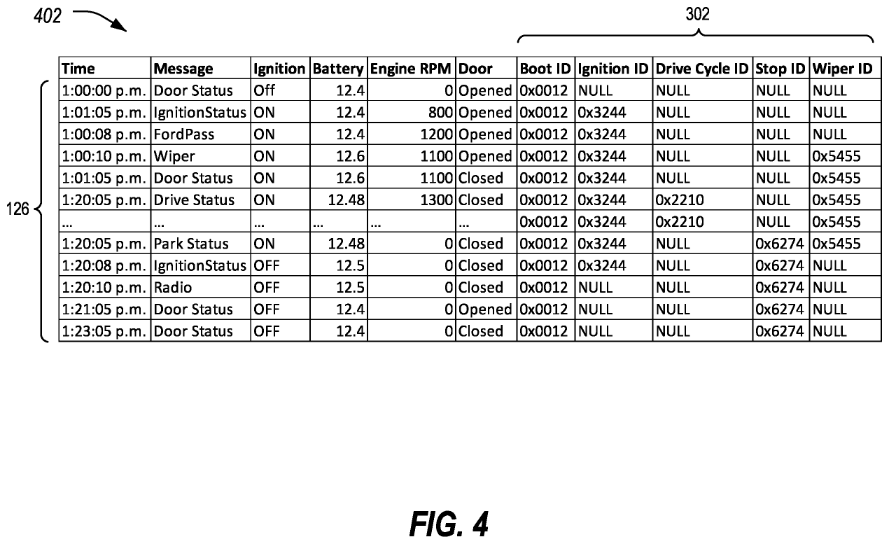

FIG. 4 illustrates an example of a data table 402 of connected data messages 126 augmented with dynamic IDs 302 as collected by the cloud server 124. These connected data message 126 may be received to the cloud server 124 from the vehicles 102, after the connected data messages 126 have been supplemented through use of the knowledge database 132. In an example, the cloud server 124 may store the connected data messages 126 in a relational database, where each of the triggers 202E is a column of the data table, and the value is either the dynamic ID 302 if the trigger 202E is activated or NULL otherwise.

Data in such a form may lend itself to being queried by the client devices 134. For example, to retrieve the connected data messages 126 related to an ignition cycle, a user of the client device 134 may query 136 for connected data messages 126 where Ignition ID !=NULL, grouped by Ignition ID, sorted by timestamp.

Similarly, a user of the client device 134 may easily group the connected data messages 126 by other defined time windows. The knowledge database 132 enables the vehicle 102 to apply the dynamic IDs 302 according to the triggers 202E. Even if the architecture of the vehicle 102 changes, as long as the data elements 202D of the vehicle 102 mean the same thing or are mapped accordingly using the knowledge database 132, the vehicle 102 may be able to utilize the triggers 202E to apply the IDs.

In other examples, the data may be stored differently. For instance, all of the dynamic IDs 302 may be stored to a single wider column, in another example.

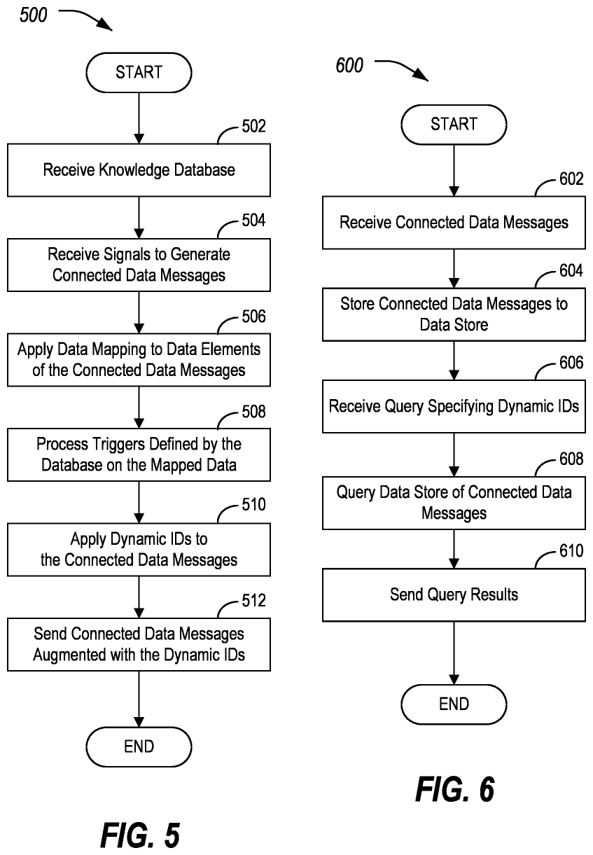

FIG. 5 illustrates an example process 500 for utilizing an ontology to augment connected data messages 126 with dynamic IDs 302. In an example the process 500 may be performed by the data mapping application 122 executed by the TCU 110 or another controller of the vehicle 102.

At operation 502, the vehicle 102 receives an knowledge database 132. The knowledge database 132 may define various ontology elements 202 such as features 202B, signals 202C, data elements 202D, and triggers 202E, as well as ontology relationships 204 between the elements. The knowledge database 132 may be used to associate connected data messages 126 with higher-level concepts, in the form of dynamic IDs 302 that may be assigned to connected data messages 126.

At operation 504, the vehicle 102 receives signals 202C. The features 202B of the vehicle 202A may generate the signals 202C based on the operation of the vehicle 202A. The signals 202C may refer to electronic messages that include information indicative of an event (or non-occurrence of an event). These messages may be continuous or discrete in nature, depending on source. These signals 202C may include, for example, messages received via the vehicle buses 108 and/or data otherwise received from the sensors 106 of the vehicle 102. These signals 202C may be incorporated into connected data messages 126 by the controllers 104 and/or the sensors 106 of the vehicle 102. For instance, the controllers 104 may receive the signals 202C and may generate connected data messages 126 and send the connected data messages 126 along the vehicle buses 108 to inform other controllers 104 of the vehicle 102 about the signals 202C.

At operation 506, the vehicle 102 applies a data mapping defined by data elements 202D of the knowledge database 132 to the connected data messages 126. In an example, the data mapping application 122 of the TCU 110 receives and processes the connected data messages 126 to identify the include data elements 202D. The data elements 202D may refer to various signals 202C that may be raised by the vehicles 202A. The data element 202D of the knowledge database 132 may serve to map disparate signals 202C across different vehicle 202A models into a consistent interface for use by the triggers 202E. An example data mapping for such a signal is shown in Table 1.

At operation 508, the vehicle 102 processes triggers 202E defined by the knowledge database 132 using the connected data messages 126 as mapped at operation 506. The triggers 202E may be defined in the knowledge database 132 in connection with the data elements 202D of the knowledge database 132. These data elements 202D of the connected data messages 126 may be compared to the triggers 202E to determine whether any of the triggers 202E have been met. In some examples, a trigger 202E may be satisfied based on the presence (or absence for a defined period of time) of a data element 202D. In other examples, a trigger 202E may be satisfied based on the occurrence of a data element 202D having a specific value. An example of data elements 202D is shown in Table 2, and an example trigger 202E utilizing the data elements of Table 2 is shown in Table 3.

At operation 510, the vehicle 102 applies dynamic IDs 302 to the connected data messages 126 based on the processing of the triggers 202E. In an example, dynamic IDs 302 corresponding to the triggers 202E that have been met at operation 508 are added to the connected data messages 126. The dynamic IDs 302 may be incorporated into the connected data messages 126 that occur during the time that the corresponding triggers 202E are satisfied. FIGS. 3-4 illustrate examples of the addition of such dynamic IDs 302.

A dynamic ID 302 for occurrence of a trigger 202E may be generated as a new unique value each time the trigger 202E occurs. Or, in another example, the dynamic IDs 302 may be pre-generated each time the vehicles 102 is started. For instance, the dynamic IDs 302 may be created responsive to the vehicle 102 loading the triggers 202E from the knowledge database 132. The dynamic IDs 302 may be generated using a hash of various values. For instance, a dynamic ID 302 may be generated as a hash of VIN, current timestamp, an incremented value, and/or an identifier of the trigger 202E that is satisfied.

At operation 512, the vehicle 102 sends the connected data messages 126 as augmented with the dynamic IDs 302. In an example, the TCU 110 sends the connected data message 126 from the vehicle 102 over the communication network 114 to the cloud server 124. The connected data message 126 may be stored and make available for querying by the cloud server 124, as discussed with respect to FIG. 6. After operation 512, the process 500 ends.

FIG. 6 illustrates an example process 600 for querying the connected data messages 126 according to the dynamic IDs 302. In an example the process 600 may be performed by the cloud server 124, which may be in communication with one or more vehicles 102 and/or client devices 134 over the communication network 114. By using the dynamic IDs 302 in the query 136, the client devices 134 may be able to select for events by concept, such as a trip, key cycle, charge cycle, or whatever other triggers 202E are defined.

At operation 602, the cloud server 124 receives connected data messages 126. In an example, the cloud server 124 may receive connected data messages 126 from vehicles 102 implementing the process 500. These connected data message 126 may include various dynamic IDs 302 added to the connected data messages 126 based on the knowledge database 132.

At operation 604, the cloud server 124 stores the connected data messages 126 to a data store 128. In an example the cloud server 124 may maintain the connected data messages 126 in a database contained by or otherwise accessible to the cloud server 124. In an example, the cloud server 124 may store the connected data messages 126 in a relational database, where each of the triggers 202E is a column of the data table, and the value is either the dynamic ID 302 if the trigger 202E is activated or NULL otherwise. An example of such a data table 402 is shown in FIG. 4.

At operation 606, the cloud server 124 receives a query 136 from a client device 134. In an example, the query 136 may be specified in a database query language, such as structured query language (SQL). The query 136 may request information from the cloud server 124 based on criteria such as vehicle identifier, time, one or more dynamic ID 302 parameters, etc. The one or more dynamic ID 302 parameters may include the association of one or more dynamic IDs 302 with the connected data messages 126. For instance, the query 136 may select connected data messages 126 for which a specific trigger 202E was active, e.g., where a dynamic ID 302 corresponding to that trigger 202E is present (e.g., non-NULL) in the connected data messages 126.

At operation 608, the cloud server 124 queries the data store 128 using the query 136. At operation 610, the cloud server 124 sends the results of the query 136 to the client device 134.

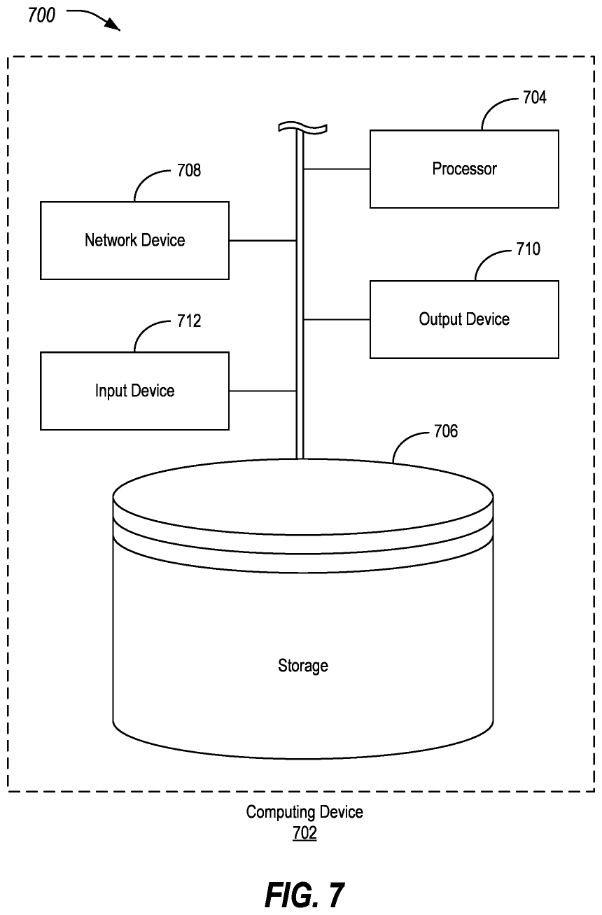

FIG. 7 illustrates an example 700 of a computing device 702 for implementing aspects of using knowledge databases 132 to conceptually group connected data messages 126 by dynamic ID 302 for enhanced data access. Referring to FIG. 7, and with reference to FIGS. 1-6, the controllers 104, sensors 106, TCU 110, processor 116, cloud servers 124, data store 128, and/or client devices 134 may be examples of such computing devices 702. As shown, the computing device 702 includes a processor 704 that is operatively connected to a storage 706, a network device 708, an output device 710, and an input device 712. It should be noted that this is merely an example, and computing devices 702 with more, fewer, or different components may be used.

The processor 704 may include one or more integrated circuits that implement the functionality of a central processing unit (CPU) and/or graphics processing unit (GPU). In some examples, the processors 704 are a system on a chip (SoC) that integrates the functionality of the CPU and GPU. The SoC may optionally include other components such as, for example, the storage 706 and the network device 708 into a single integrated device. In other examples, the CPU and GPU are connected to each other via a peripheral connection device such as peripheral component interconnect (PCI) express or another suitable peripheral data connection. In one example, the CPU is a commercially available central processing device that implements an instruction set such as one of the x86, ARM, Power, or microprocessor without interlocked pipeline stage (MIPS) instruction set families.

Regardless of the specifics, during operation the processor 704 executes stored program instructions that are retrieved from the storage 706. The stored program instructions, accordingly, include software that controls the operation of the processors 704 to perform the operations described herein. The storage 706 may include both non-volatile memory and volatile memory devices. The non-volatile memory includes solid-state memories, such as negative-AND (NAND) flash memory, magnetic and optical storage media, or any other suitable data storage device that retains data when the system is deactivated or loses electrical power. The volatile memory includes static and dynamic random-access memory (RAM) that stores program instructions and data during operation of the system 100.

The GPU may include hardware and software for display of at least two-dimensional (2D) and optionally three-dimensional (3D) graphics to the output device 710. The output device 710 may include a graphical or visual display device, such as an electronic display screen, projector, printer, or any other suitable device that reproduces a graphical display. As another example, the output device 710 may include an audio device, such as a loudspeaker or headphone. As yet a further example, the output device 710 may include a tactile device, such as a mechanically raiseable device that may, in an example, be configured to display braille or another physical output that may be touched to provide information to a user.

The input device 712 may include any of various devices that enable the computing device 702 to receive control input from users. Examples of suitable input devices that receive human interface inputs may include keyboards, mice, trackballs, touchscreens, voice input devices, graphics tablets, and the like.

The network devices 708 may each include any of various devices that enable the vehicles 102 and cloud server 124 to send and/or receive data from external devices over networks. Examples of suitable network devices 708 include an Ethernet interface, a Wi-Fi transceiver, a cellular transceiver, or a BLUETOOTH or BLUETOOTH Low Energy (BLE) transceiver, or other network adapter or peripheral interconnection device that receives data from another computer or external data storage device, which can be useful for receiving large sets of data in an efficient manner.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read-only memory (ROM) devices and information alterably stored on writeable storage media such as floppy disks, magnetic tapes, compact discs (CDs), RAM devices, and other magnetic and optical media. The processes, methods, or algorithms can also be implemented in a software executable object. Alternatively, the processes, methods, or algorithms can be embodied in whole or in part using suitable hardware components, such as Application Specific Integrated Circuits (ASICs), Field-Programmable Gate Arrays (FPGAs), state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to strength, durability, life cycle, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The abstract of the disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separately claimed subject matter.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system for using a knowledge database to augment connected data messages, comprising:
a storage of a vehicle, configured to maintain a knowledge database describing a plurality of triggers, each trigger including a first condition for activating the trigger and a second condition for deactivating the trigger; and
a controller of the vehicle, programmed to
process the triggers defined by the knowledge database, including to compare data elements of the connected data messages with the conditions of the triggers, and
augment each of the connected data messages that occur while the respective trigger is activated with a generated dynamic ID corresponding to the activating of the respective trigger.

2. The system of claim 1, wherein the knowledge database includes a data element mapping of signals of the vehicle to the data elements of the knowledge database.

3. The system of claim 1, wherein the controller is further programmed to:
receive the knowledge database over a communication network from a cloud server; and
send the augmented connected data messages to the cloud server.

4. The system of claim 1, wherein the plurality of triggers including a first trigger that indicates to begin to apply a first dynamic ID to the connected data messages responsive to a first data element being set to a first value and to discontinue applying the first dynamic ID to the connected data messages responsive to the first data element being set to a second value.

5. The system of claim 1, wherein the plurality of triggers including a second trigger that indicates to begin to apply a second dynamic ID to the connected data messages responsive to a second data element being observed and to discontinue applying the second dynamic ID to the connected data messages responsive to a third data element being observed.

6. The system of claim 1, wherein the controller is further programmed to generate the dynamic ID using a hash of values including an identifier of the vehicle, a current time, an incremented value, and/or an identifier of the respective trigger that is satisfied.

7. The system of claim 1, wherein the controller is further programmed to:
apply a first dynamic ID to the connected data messages that occur between a first activation of a first trigger and a first deactivation of the first trigger; and
apply a second dynamic ID to the connected data messages that occur between a second activation of the first trigger and a second deactivation of the first trigger,
wherein the first dynamic ID and the second dynamic ID are different values.

8. The system of claim 1, wherein the controller is further programmed to:
apply a first dynamic ID to the connected data messages that occur between an activation of a first trigger and a deactivation of the first trigger; and
apply a second dynamic ID to the connected data messages that occur between an activation of a second trigger and a deactivation of the second trigger,
wherein the first dynamic ID and the second dynamic ID are different values, and wherein the activation of the first trigger and the activation of the second trigger at least partially overlap such that the first and second dynamic IDs are both applied to the connected data messages within the overlap.

9. A method for using a knowledge database to augment connected data messages, comprising:
maintaining, to a storage of a vehicle, a knowledge database describing a plurality of triggers, each trigger including a first condition for activating the trigger and a second condition for deactivating the trigger;
processing, by a controller of the vehicle, the triggers defined by the knowledge database, including to compare data elements of the connected data messages with the conditions of the triggers; and
augmenting, by the controller of the vehicle, each of the connected data messages that occur while the respective trigger is activated with a generated dynamic ID corresponding to the activating of the respective trigger.

10. The method of claim 9, wherein the knowledge database includes a data element mapping of signals of the vehicle to the data elements of the knowledge database.

11. The method of claim 9, further comprising:
receiving the knowledge database over a communication network from a cloud server; and
sending the augmented connected data messages to the cloud server.

12. The method of claim 11, further comprising:
storing the connected data messages to a data table of a relational database, wherein each row of the data table represents one of the connected data messages, each of the triggers is represented by a respective column of the data table, wherein the value of the respective column is either the dynamic ID if the trigger is activated for the connected data messages or NULL otherwise.

13. The method of claim 11, further comprising:
receiving, by the cloud server from a client device, a query for connected data messages, the query specifying at least one dynamic ID is non-NULL;
querying a data store accessible to the cloud server using the query; and
sending the results of the query to the client device.

14. The method of claim 9, wherein the plurality of triggers including a first trigger that indicates to begin to apply a first dynamic ID to the connected data messages responsive to a first data element being set to a first value, and to discontinue applying the first dynamic ID to the connected data messages responsive to the first data element being set to a second value.

15. The method of claim 9, wherein the plurality of triggers including a second trigger that indicates to begin to apply a second dynamic ID to the connected data messages responsive to a second data element being observed, and to discontinue applying the second dynamic ID to the connected data messages responsive to a third data element being observed.

16. The method of claim 9, wherein the controller is further programmed to generate the dynamic ID using a hash of values including an identifier of the vehicle, a current time, an incremented value, and/or an identifier of the respective trigger that is satisfied.

17. The method of claim 9, wherein the controller is further programmed to:
apply a first dynamic ID to the connected data messages that occur between a first activation of a first trigger and a first deactivation of the first trigger; and
apply a second dynamic ID to the connected data messages that occur between a second activation of the first trigger and a second deactivation of the first trigger, wherein the first dynamic ID and the second dynamic ID are different values.

18. The method of claim 9, wherein the controller is further programmed to:
apply a first dynamic ID to the connected data messages that occur between an activation of a first trigger and a deactivation of the first trigger; and
apply a second dynamic ID to the connected data messages that occur between an activation of a second trigger and a deactivation of the second trigger,
wherein the first dynamic ID and the second dynamic ID are different values, and wherein the activation of the first trigger and the activation of the second trigger at least partially overlap such that the first and second dynamic IDs are both applied to the connected data messages within the overlap.

19. A non-transitory computer-readable medium comprising instructions for using a knowledge database to augment connected data messages that, when executed by a processor of a controller of a vehicle, cause the controller to perform operations including to:
receive a knowledge database over a communication network from a cloud server, the knowledge database including a data element mapping of signals of the vehicle to data elements of the knowledge database and a plurality of triggers, each trigger including a first condition for activating the trigger and a second condition for deactivating the trigger;
process, by a controller of the vehicle, the triggers defined by the knowledge database, including to compare data elements of the connected data messages with the conditions of the triggers;
augment, by the controller of the vehicle, each of the connected data messages that occur while the respective trigger is activated with a generated dynamic ID corresponding to the activating of the respective trigger; and
send the augmented connected data messages to the cloud server.

20. The non-transitory computer-readable medium of claim 19, further comprising instructions that, when executed by the processor of the controller of the vehicle, cause the controller to perform operations including to generate the dynamic ID using a hash of values including an identifier of the vehicle, a current time, an incremented value, and/or an identifier of the respective trigger that is satisfied.
